(19) United States
(12) Patent Application Publication
(10) Pub. No.: US 2008/0070641 A1
(43) Pub. Date: Mar. 20, 2008

(54) Holder for portable electronic device

(75) Inventor: Chin-Yang Wang, Tainan Hsien (TW)

Correspondence Address: BACON & THOMAS, PLLC, 625 SLATERS LANE, FOURTH FLOOR, ALEXANDRIA, VA, 22314, US

(73) Assignee: ARKON Resources, Inc., Arcadia, CA (US)

(21) Appl. No.: 11/521,400

(22) Filed: Sep. 15, 2006

(51) Int. Cl. H04M 1/00

(52) U.S. Cl. 455/569.1; 455/575.1

(57) ABSTRACT

The present invention is to provide a holding device comprising a holding seat adapted to support and fasten a portable electronic device and including a plurality of apertures therethrough; a base affixed to a planar surface; and a fastening assembly having one end moveably mounted on one end of the base and including two opposite clamping units at the other end; wherein each of the clamping units is adapted to either pass the two apertures at the same side of the holding seat to fasten edges of the apertures for clamping the holding seat on the fastening assembly or disengage from the holding seat for detaching both the holding seat and the clamping unit without causing damage to the holding device due to excessive amount of force exertion thereupon.

### FIELD OF THE INVENTION

The present invention relates to holders and more particularly to a device for supporting a portable electronic device (e.g., PDA (Personal Digital Assistant), mobile phone, or the like) on a planar surface, for example, the dashboard of an automobile.

### BACKGROUND OF THE INVENTION

The availability of various electronic products is even faster as technologies make progress significantly in recent several decades. As a result, a lot of convenience is brought to our daily life and living quality is improved significantly. Moreover, such new electronic products are closely associated with our daily life and work. For example, some types of consumer-oriented portable electronic products (e.g., PDAs (Personal Digital Assistants), mobile phones, etc.) are widely used today. Such electronic products are characterized in being compact and lightweight. In addition, many advanced features including notebook, calendar, database, video game, phone book, English-Chinese dictionary, graphics, and calculator are added therein. This greatly stimulates the sales of such portable electronic devices in the market. And in turn, a great investment on the research and development of the portable electronic devices by major manufacturers of the art is made. Such investment aims at producing more lightweight, slim, and compact electronic products with enhanced functions.

One of a number of typical applications of the portable electronic devices is personal information manager, video game machine, music player, or navigation tool. Typically, a user (e.g., a driver) may mount a portable electronic device on a holder secured onto a suitable substrate such as the dashboard of an automobile. Thereafter, the user may conveniently, easily use the portable electronic device. Further, the user may tilt the holder relative to him in order to operate the electronic device or view messages shown on the display thereof while driving.

For example, U.S. Pat. No. 5,740,995 discloses a “Device for Supporting Objects” as shown in FIGS. 1 and 2. The object can be a mobile phone. The device is mounted on a suitable substrate such as the dashboard of a vehicle. The device comprises a base 12 and a carrier plate 30. The base 12 comprises four rectangularly arrayed interlocking elements 18 on its top inclined surface. The carrier plate 30 comprises four generally L-shaped apertures 39 formed therein. Each of the L-shaped apertures 39 is adapted to securely receive one of the interlocking elements 18 after applying a sufficient force upon the carrier plate 30 to move same along the top surface of the base 12 until being stopped. As an end, the base 12 and the carrier plate 30 are secured together.

However, the prior art patent suffered from a couple disadvantages. For example, a user has to exert a great force to disengage the base 12 with the carrier plate 30 due to the very tight interlocking engagement of the interlocking elements 18 in the apertures 39. This time consuming disengagement process is not desired and may cause inconvenience in use. Further, the holder tends to be damaged in the disengagement process. Hence, a need has arisen for an improved holder for portable electronic device.

### SUMMARY OF THE INVENTION

After considerable research and experimentation, a holder for portable electronic device according to the present invention has been devised so as to overcome the above drawbacks of the prior art.

It is an object of the present invention to provide a holding device comprising a holding seat adapted to support and fasten a portable electronic device and including a plurality of apertures therethrough; a base affixed to a planar surface; and a fastening assembly having one end moveably mounted on one end of the base and including two opposite clamping units at the other end; wherein each of the clamping units is adapted to either pass the two apertures at the same side of the holding seat to fasten edges of the apertures for clamping the holding seat on the fastening assembly or disengage from the holding seat for detaching both the holding seat and the clamping unit. By utilizing this holding device, it is possible of easily mounting the holding seat on the fastening assembly or detaching the holding seat therefrom without causing damage to the holder due to excessive amount of force exertion thereupon.

The above and other objects, features and advantages of the present invention will become apparent from the following detailed description taken with the accompanying drawings.

### BRIEF DESCRIPTION OF THE DRAWINGS

FIG. 1 is a top view of a device for supporting object according to prior art where the carrier plate is positioned on the base but not interlocked therewith;

FIG. 2 is a view similar to FIG. 1 where the carrier plate is interlocked with the base;

FIG. 3 is an environmental view of a preferred embodiment of holder according to the invention where a mobile phone is held by the holder;

FIG. 4 is an exploded perspective view of the holder shown in FIG. 3; and

FIG. 5 is an enlarged view of the fastening assembly shown in FIG. 4.

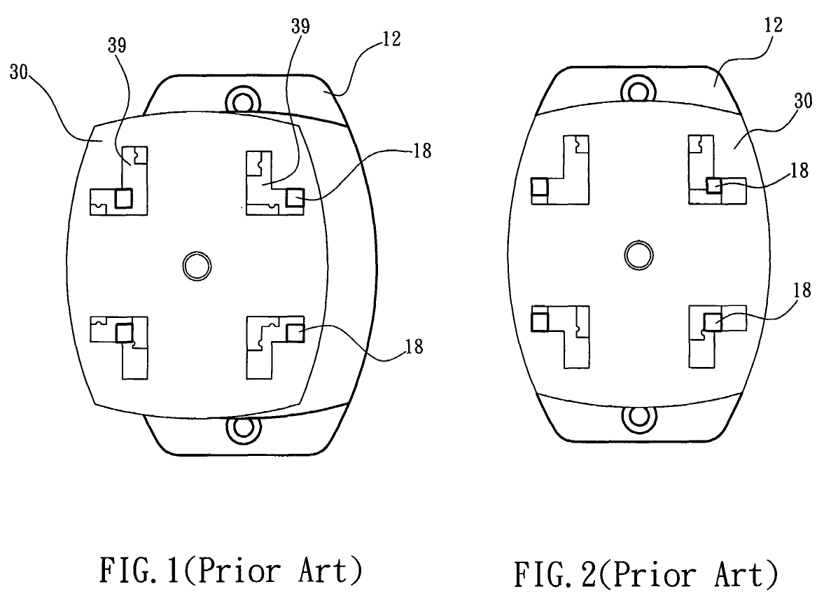

### DETAILED DESCRIPTION OF THE PREFERRED EMBODIMENTS

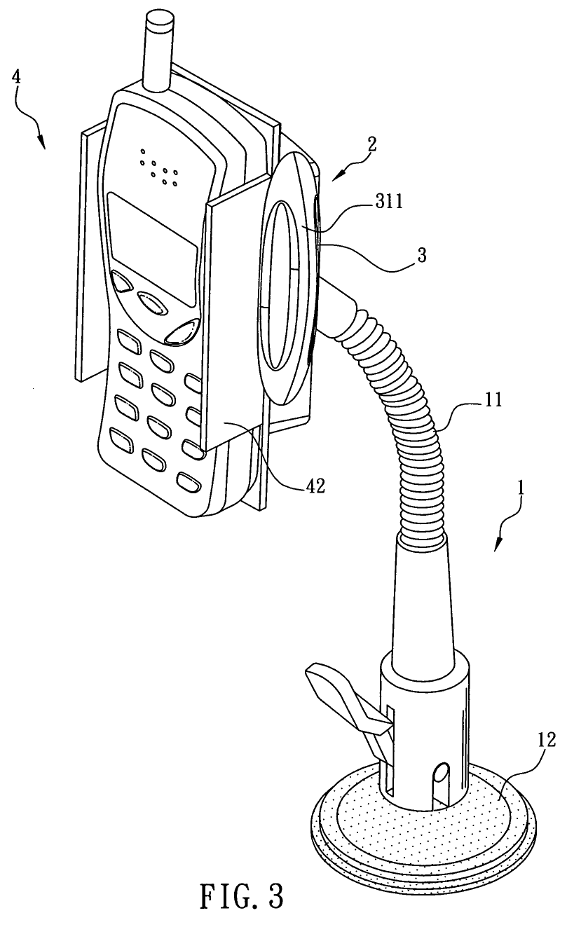

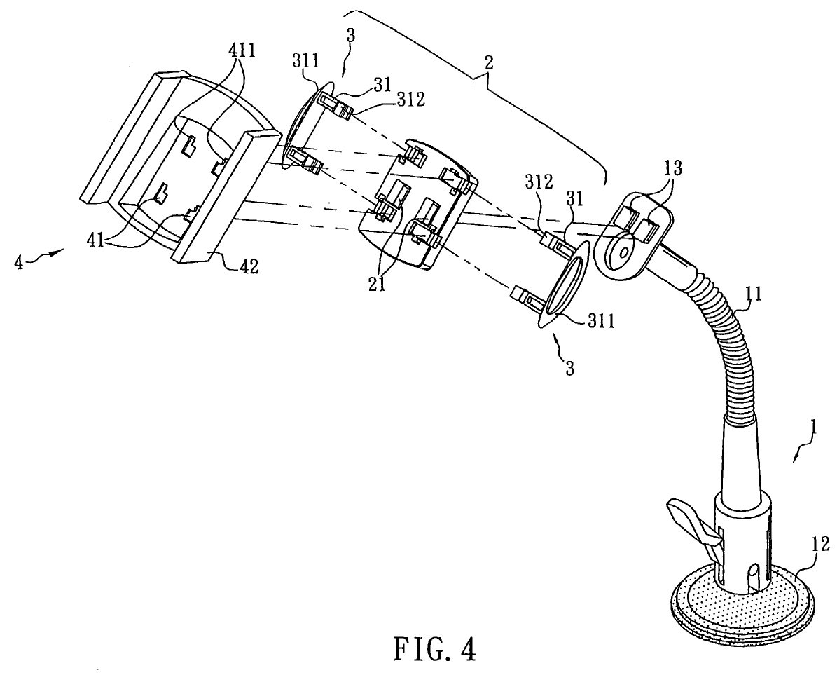

Referring to FIGS. 3 and 4, a holder for supporting a portable electronic device in accordance with a preferred embodiment of the invention is shown. The holder comprises a base 1 having one end secured onto a planar surface and the other end flexibly connected to a fastening assembly 2. The fastening assembly 2 comprises a plurality of clamping units (two opposite clamping units are shown) 3 at the distal other end of the base 1. A holding seat 4 is secured to the fastening assembly 2 and is adapted to clamp a portable electronic device (e.g., mobile phone as shown). The holding seat 4 is of substantially U-section and comprises a plurality of L-shaped apertures (four rectangularly arrayed apertures are shown) 41 through its bottom. Each of the clamping units 3 is adapted to pass the two apertures 41 at the same side of the holding seat 4. Further, the clamping units 3 are adapted to move toward each other with edges of the apertures 41 of the holding seat 4 being fastened by the clamping units 3. As a result, the holding seat 4 is securely mounted onto the base 1. Alternatively, disengaging the clamping units 3 with the holding seat 4 will detach the holding seat 4 from the base 1. As an end, the purpose of detaching the holding seat 4 is achieved. In such a manner, it is possible of easily mounting the holding seat 4 on the fastening assembly 2 or detaching the holding seat 4 from the fastening assembly 2. As an end, the prior art drawback of damaging the holder due to excessive amount of force exertion upon the holding seat 4 is eliminated.

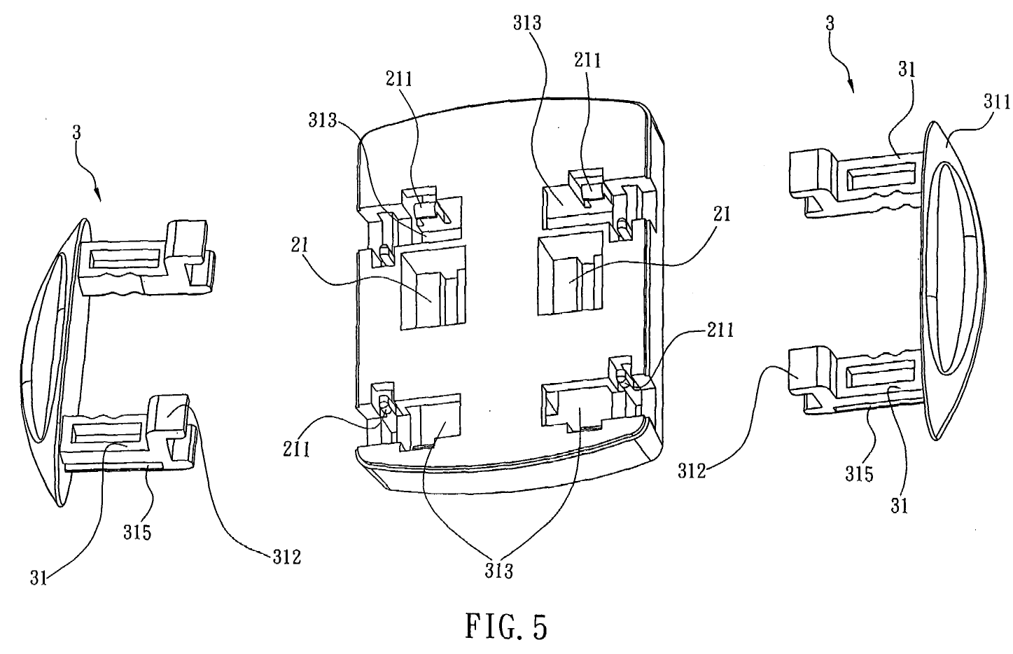

Referring to FIG. 5 in conjunction with FIG. 4, in the preferred embodiment of the invention the U-shaped clamping unit 3 comprises two side wings 31 and an elongate handle portion 311 having both ends each formed with the other end of the wing 31. The wing 31 comprises at least one latch (one is shown) 312 at one end. The latch 312 is shaped as a U. On the surface of the fastening assembly 2 facing the holding seat 4 there are provided four rectangularly arrayed slots 313 each adapted to slidably receive the latch 312 of either wing 31. The latches 312 are adapted to insert into the corresponding apertures 41 with the openings thereof engaged with the edges of the apertures 41. Further, pushing both the handle portions 311 toward each other to move the wings 31 along the slots 313 will cause the latches 312 of one handle portion 311 to be close to that of the other handle portion 311 until the edges of the apertures 41 are urged by the latches 312 and both sides of the holding seat 4 are clamped by the handle portions 311. As an end, the holding seat 4 is clamped by the clamping units 3 without being subject to disengagement.

Referring to FIGS. 4 and 5 again, in the embodiment each wing 31 comprises a side groove 315 adapted to dispose in the slot 313 when the clamping unit 3 and the fastening assembly 2 are secured together. The fastening assembly 2 comprises four projections 211 each provided in the slot 313 facing the groove 315. An open end of each projection 211 is adapted to insert into the groove 315 and slide therein. This can decrease friction when the wing 31 moves in the corresponding slot 313, thereby facilitating the movements of the wings 31 in the slots 313. The fastening assembly 2 further comprises at least one staged cavity (two are shown) 21 on its surface facing the holding seat 4. The base 1 comprises a flexible arm 11 extended upwardly, a lower, circular suction section 12 adapted to mount on a planar surface by suction, and at least one (two are shown) projecting interlocking member 13 formed at an open end of the arm 11. The interlocking members 13 are adapted to insert into the cavities 21 to securely engage the base 1 with the fastening assembly 2.

Referring to FIGS. 4 and 5 again, the holding seat 4 further comprises two side plates 42 for securely mounting the electronic device therebetween by clamping. As a result, the electronic device is prevented from disengaging with the holding seat 4. A slit 411 is formed in each aperture 41 and has an opening smaller than that of the aperture 41. An open end of the latch 312 is adapted to insert into the aperture 41 and then moves along the slit 411 until being locked. As an end, the clamping unit 3 and the holding seat 4 are secured together.

While the invention herein disclosed has been described by means of specific embodiments, numerous modifications and variations could be made thereto by those skilled in the art without departing from the scope and spirit of the invention set forth in the claims.

What is claimed is:

1. A holding device comprising:
a holding seat adapted to support and fasten a portable electronic device and including a plurality of apertures therethrough;
a base affixed to a planar surface; and
a fastening assembly having one end moveably mounted on one end of the base and including two opposite clamping units at the other end;
wherein each of the clamping units is adapted to either pass the two apertures at the same side of the holding seat to fasten edges of the apertures for clamping the holding seat on the fastening assembly or disengage from the holding seat for detaching both the holding seat and the clamping unit.

2. The holding device of claim 1, wherein the clamping unit is shaped as a U and comprises:
two side wings each including at least one latch at one open end, the latches of the opposite wings being adapted to either insert into the corresponding apertures for approaching the holding seat or clear same for moving away from the holding seat; and
a handle portion interconnected the wings.

3. The holding device of claim 2, further comprising four rectangularly arrayed slots formed on a surface of the fastening assembly facing the holding seat, each of the slots adapted to slidably receive the latch of the wing.

4. The holding device of claim 3, wherein each of the wings comprises a groove adapted to dispose in the slot when the clamping units and the fastening assembly are secured together, and wherein the fastening assembly further comprises four projections each formed in the slot facing the groove, each of the projections has an open end adapted to insert into the groove and slide therein.

5. The holding device of claim 3, wherein each of the latches is shaped as a U.

6. The holding device of claim 1, wherein each of the apertures comprises a slit formed therein, the slit having an opening smaller than that of the aperture so as to lock an open end of the latch inserted into the aperture.

7. The holding device of claim 6, wherein the holding seat is of U-section and further comprises two side plates for securely mounting the electronic device therebetween.

8. The holding device of claim 2, wherein fastening assembly further comprises at least one staged cavity on the surface facing the holding seat, and wherein the base comprises a flexible arm extended upwardly, a lower suction section adapted to mount on the planar surface, and at least one projecting interlocking member formed at an open end of the arm, each interlocking member being adapted to insert into the cavity to securely engage the base with the fastening assembly.
